(19) United States
(12) Patent Application Publication
(10) Pub. No.: US 2022/0338641 A1
(43) Pub. Date: Oct. 27, 2022

(54) MATTRESSES, CUSHIONS, AND BODY-SUPPORT PADS OR MATS WITH DEFORMABLE WALLS HAVING FIBER STRANDS EMBEDDED THEREIN

(71) Applicants: Soft-Tex International, Inc., Waterford, NY (US); Serta Simmons Bedding, LLC, Doraville, GA (US)

(72) Inventors: Mark SMIDERLE, Midhurst (CA); Sheri L. McGUIRE, Duluth, GA (US); Richard GLADNEY, Fairburn, GA (US); Danielle IGNAZZI, Emerson, NJ (US); Carl Hilton POWELL, JR., Amelia, OH (US); Lloyd J. WILSON, Saratoga Springs, NY (US)

(21) Appl. No.: 17/729,357

(22) Filed: Apr. 26, 2022

Related U.S. Application Data
(60) Provisional application No. 63/180,528, filed on Apr. 27, 2021.

(51) Int. Cl. A47C 27/05; A47C 27/12; A47C 27/14

(52) U.S. Cl. CPC A47C 27/05; A47C 27/122; A47C 27/14

(57) ABSTRACT

Mattresses, cushions, and body-support mats or pads include a plurality of layers extending in a depth direction from a resting surface, where the resting surface is capable of supporting user(s), to a lower surface, the lower surface being opposite the resting surface. The plurality of layers include a comfort layer that forms an upper layer proximate to the resting surface, where the comfort layer includes deformable walls separated by voids and the deformable walls include a plurality of fiber strands embedded in a cushioning media.

### CROSS REFERENCE TO RELATED APPLICATIONS

The present application claims the benefit of U.S. Provisional Application 63/180,528 filed on Apr. 27, 2021, incorporated herein by reference in its entirety.

### BACKGROUND

The present disclosure generally relates to a mattress, cushions, and body-support pads or mats and more particularly to mattresses, cushions and body-support pads or mats with deformable walls.

Foam mattresses/cushions made of, e.g., polyurethane foam or the like provide rebound pressure in response to an object applying a force to the foam. Upon removal of the object, the rebound pressure causes the foam to return to its original shape. The deeper an object sinks into a foam, the higher the rebound pressure. Foam mattresses can create centralized pressure areas due to the rebound pressure increasing at the areas with the most pressure. For example, the foam applies the highest amount of pressure to protruding portions of an object being cushioned since the pressure on the object is not equalized. Such mattresses/cushions can cause discomfort for users by creating centralized pressure areas. Alternative materials such as fluid cushions/mattresses and gel cushions/mattresses have been used to equally distribute pressure applied by an object.

Another disadvantage of existing foam mattresses is that foam can retain heat. During use, body-generated heat can accumulate in the bedding due to the foam's tendency to store rather than dissipate heat. Specifically, while the body of a user is in contact with the mattress/cushion, body-generated heat is transferred to and stored in the immediate contact area of the mattress/cushion, which can result in a localized temperature rise. The heat that the mattress/cushion collects can radiate back to the user and warm the user.

In contrast, mattresses having a top or comfort layer made from gel tend to provide a cooling effect. This cooling effect can be more comfortable to a user, particularly in certain climates. Many mattresses with a gel comfort layer also include a plurality of voids/pockets formed by gel walls. The voids/pockets can create a space for airflow through the mattress/cushion. Additionally, the gel walls are configured to buckle under pressure from the object, which may result in less rebound pressure being applied to protruding portions of an object relative to foam mattresses/cushions. Another advantage of having voids/pockets is that gel comfort layers can be expensive due to the material composition of the gel, and the voids/pockets in the comfort layer can provide air pockets that help reduce costs by reducing the amount of gel in the cushion/mattress.

However, existing mattresses with gel comfort layers are often quite heavy, with a twin XL mattress weighing approximately 70 lbs., a queen mattress weighing approximately 110 lbs., and a king mattress weighing approximately 140 lbs. Further, although the voids/pockets reduce the amount of gel used in the mattress relative to a mattress with a solid gel layer, mattresses having a gel comfort layer can still be relatively expensive to produce due to the amount of gel still used in the comfort layer. Therefore, a need exists in the art for improved mattresses cushions, and body-support pads or mats.

While certain aspects of conventional technologies have been discussed to facilitate disclosure of the invention, in no way are technical aspects that are not described disclaimed and it is contemplated that the claimed invention may encompass one or more of the technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant in an attempt to solve any problem with which this specification is concerned.

### SUMMARY

Shortcomings of the prior art are overcome and additional advantages are provided through improved mattress, cushions, and body-support pads or mats disclosed herein. The presently described mattresses, cushions, and body-support pads or mats address one or more of the problems and deficiencies of the art discussed above. However, it is contemplated that the disclosed mattresses, cushions, and body-support pads or mats may prove useful in addressing other problems and deficiencies in a number of technical areas. Therefore, the disclosed mattresses, cushions, and body-support pads or mats should not necessarily be construed as limited to addressing any of the particular problems or deficiencies discussed herein.

Certain embodiments of the presently disclosed mattresses, cushions, and body-support pads or mats have several features, no single one of which is solely responsible for their desirable attributes. Without limiting the scope of the mattresses, cushions, and body-support pads or mats as defined by the claims that follow, the more prominent features of these items will now be discussed briefly.

In one aspect, disclosed herein are mattresses that include a plurality of layers extending in a depth direction from a resting surface of the mattress capable of supporting one or more users of the mattress to a lower surface of the mattress, the lower surface being opposite the resting surface. The mattresses also include a comfort layer of the plurality of layers, where the comfort layer forms an upper layer proximate to the resting surface of the mattress. The comfort layer includes deformable walls separated by voids, where the deformable walls include a plurality of fiber strands embedded in a cushioning media.

In another aspect, disclosed herein are cushions that include a plurality of layers extending in a depth direction from a resting surface of the cushion that is capable of supporting one or more users of the cushion to a lower surface of the cushion, the lower surface being opposite the resting surface. The cushions also include a comfort layer of the plurality of layers, where the comfort layer forms an upper layer proximate to the resting surface of the cushion. The comfort layer includes deformable walls separated by voids, where the deformable walls include a plurality of fiber strands embedded in a cushioning media.

In another aspect, disclosed herein are body-support pads or mats that include a plurality of layers extending in a depth direction from a resting surface of the body-support pad or mat that is capable of supporting one or more users of the body-support pad or mat to a lower surface of the body-support pad or mat, the lower surface being opposite the resting surface. The body-support pads or mats also include a comfort layer of the plurality of layers, where the comfort layer forms an upper layer proximate to the resting surface of the body-support pad or mat. The comfort layer includes deformable walls separated by voids, where the deformable walls include a plurality of fiber strands embedded in a cushioning media.

These and other features and advantages of the disclosure and inventions will become apparent from the following detailed description of the various aspects of the invention taken in conjunction with the appended claims and the accompanying drawings.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings, which are not necessarily drawn to scale, wherein:

FIG. 1 depicts an elevational perspective view of an exemplary mattress, according to one or more embodiments of the present disclosure;

FIG. 2 depicts a cross-sectional view of the corner of the mattress of FIG. 1, according to the present disclosure;

FIG. 3 depicts an elevational perspective view of a plurality of layers used, for example, in a mattress, cushion, body-support pad or mat, according to one or more embodiments of the present disclosure;

FIG. 4 depicts an elevational perspective view of a comfort layer of a mattress, according to one or more embodiments of the present disclosure;

FIG. 5 depicts a cross sectional side view of deformable walls of a comfort layer, according to one or more embodiments of the present disclosure; and

FIG. 6 depicts a transparent view of deformable walls that include a plurality of fiber strands embedded in a cushioning media, according to one or more embodiments of the present disclosure.

### DETAILED DESCRIPTION

Aspects of the present disclosure and certain features, advantages, and details thereof, are explained more fully below with reference to the non-limiting embodiments illustrated in the accompanying drawings. Descriptions of well-known materials, fabrication tools, processing techniques, etc., are omitted so as to not unnecessarily obscure the details of the inventions. It should be understood, however, that the detailed description and the specific example(s), while indicating embodiments of inventions of the present disclosure, are given by way of illustration only, and are not by way of limitation. Various substitutions, modifications, additions and/or arrangements within the spirit and/or scope of the underlying inventive concepts will be apparent to those skilled in the art from this disclosure.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±0.5%. In some instances, the approximating language may correspond to the precision of an instrument for measuring the value.

Disclosed herein mattresses, cushions, and body-support pads or mats. As used herein, the terms “mattress,” “cushion,” “body-support cushion,” “support cushion” and “body-support pad/mat” may be used interchangeably to refer to any and all such objects having any sized and shape or that are otherwise configured to and capable of supporting at least a portion of the body of a user. Although some exemplary embodiments of the disclosed body-support cushions of the present disclosure are illustrated and/or described in the form of mattresses, mattress toppers, mattress pads, body-support pillows, and/or mattress protectors and may be dimensionally sized or shaped to support the entire or the majority of the body of a user, it is contemplated that the aspects and features described therewith are equally applicable to head pillows, seat cushions, seat backs, lumbar supports, back supports, neck supports, furniture (e.g., chairs, ottomans, chair pads, couch cushions, futons, massage tables, and seats), infant carriers, protective equipment (e.g. medical pads, sports pads, helmets), leg spacers, apparel (e.g., shoe soles, insoles, sock liners, hats, and backpacks), pet accessories (e.g., pet beds, pet carrier inserts, pet apparel), exercise equipment cushions (e.g., yoga mats, gym mats), construction materials (e.g. flooring, wall panels/mats) and the like.

The mattresses, cushions, and body-support pads or mats include a plurality of layers extending in a depth direction from a resting surface that is capable of supporting one or more users to a lower surface that is opposite the resting surface. Further, the plurality of layers includes a comfort layer that forms an upper layer proximate to the resting surface of the mattress, where the comfort layer includes deformable walls separated by voids. Additionally, the deformable walls include a plurality of fiber strands embedded in a cushioning media.

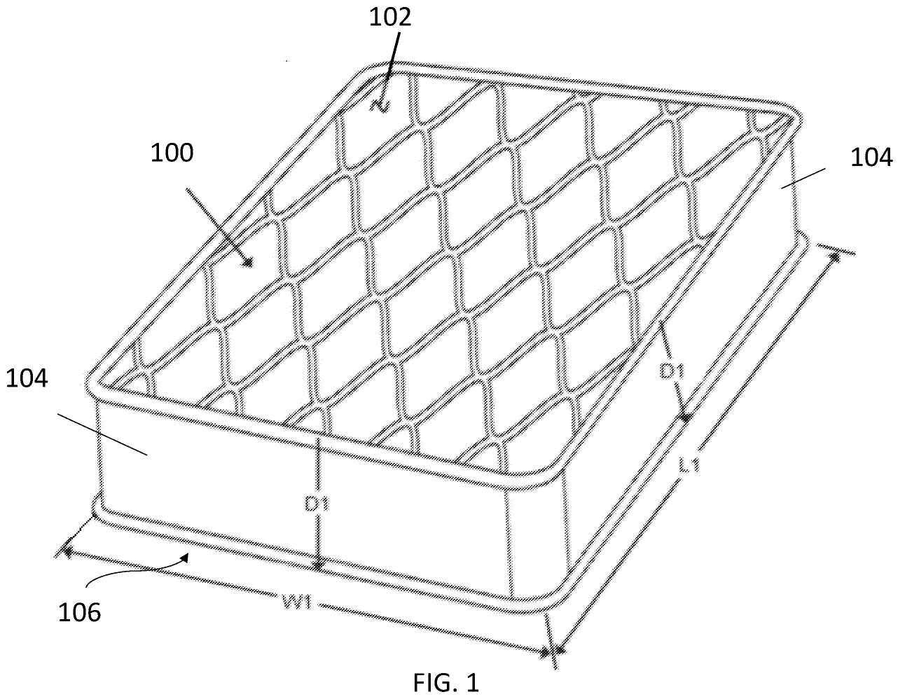

Referring now to FIG. 1, an elevational perspective view of an exemplary mattress 100 is depicted. The mattress 100 includes a resting surface 102 and a plurality of side surfaces 104 that extend in a depth direction D1 away from the resting surface 102 to a lower surface 106 of the mattress 100, where the lower surface 106 is opposite the resting surface 102. For instance, the resting surface 102 may be a top side of the mattress 100 whereas the lower surface 106 may be an underside of the mattress 100. The resting surface 102 may be relatively planar and capable of supporting one or more users thereon. According to one embodiment, the mattress 100 may be reversible such that the resting surface 102 may become the underside of the mattress 100 and the lower surface 106 may become the top side of the mattress 100. The mattress 100 may traverse a width W1 and a length L1, where the length can be a longer distance than the width.

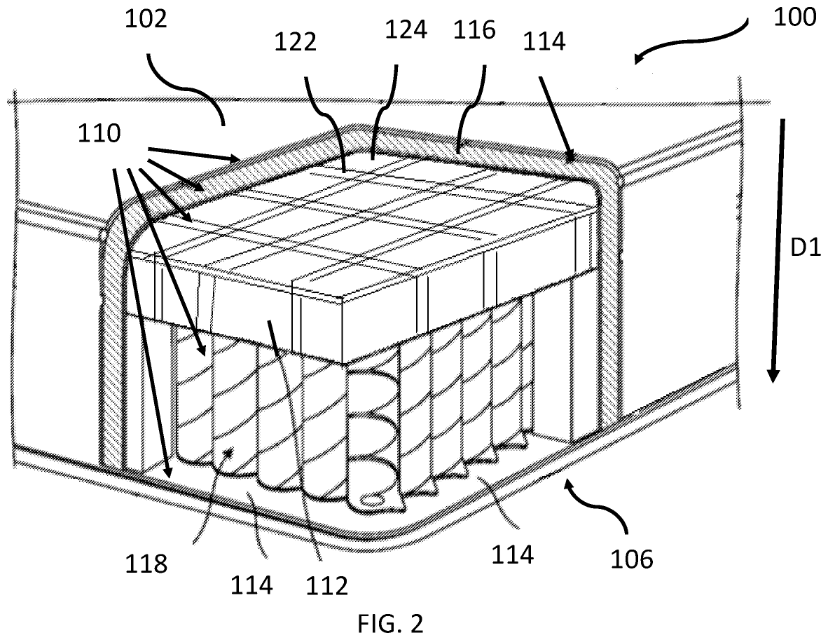

Referring now to FIG. 2, a cross-sectional view of a corner of the mattress 100 of FIG. 1 is depicted. The mattress 100 may include a plurality of layers 110 that extend in a depth direction D1 from the resting surface 102 of the mattress 100 to the lower surface 106 of the mattress 100.

The plurality of layers 110 include a comfort layer 112 that forms an upper layer proximate to the resting surface of the mattress 100. The comfort layer 112 includes deformable walls 122 separated by voids 124. By way of example, the illustrated comfort layer can have a grid like pattern of deformable walls providing a square shaped void. However, it should be noted that the deformable walls and voids are not intended to be limited to the grid-like pattern as shown. Other patterns are contemplated. The deformable walls 122 include a plurality of fiber strands embedded in a cushioning media such as foam, for example. The comfort layer 112 may include a height within a range of about 0.5 inches to about 4 inches, 1 inch to about 3 inches, or have a height of about 2 inches. The deformable walls 122 of the comfort layer 112 may be configured as buckling walls capable of buckling due to pressure applied by an object. In order for the deformable walls 122 to deform, an energy or force applied to the deformable walls 122 may cause the deformable walls 122 to deform/buckle and when the force or energy is removed the deformable walls 122 may rebound such that the deformable walls 122 return to their original form. The deformable walls 122 may absorb energy from the force applied to the deformable walls 122 and attenuate shock/vibration, which advantageously provide pressure equalization and/or redistribution. According to one embodiment, when high protrusion forces (e.g. from hips, shoulders, etc.) apply pressure to the deformable walls 122, the deformable walls 122 may substantially buckle or deform, whereas when low protrusion forces (e.g. from feet, lower legs, etc.) may not provide sufficient force for the deformable walls 122 to deform/buckle. For instance, the deformable walls 122 may include a pressure buckling threshold at which point the deformable walls 122 may deform/buckle when the pressure surpasses the buckling threshold. According to various embodiments, the deformable walls 122 include a composition of materials capable of providing a rebound force due to compression from a substantially planar load. The rebound force due to the compression may range from about 100 kg/m² to about 400 kg/m². The deformable walls 122 may be capable of distributing body weight of one or more users to conform to the body shape of the one or more users. The deformable walls may be sized and shaped or otherwise configured to buckle or deform such that the height of the deformable walls decreases a distance within a range of about 5% to about 85% in response to a load from the one or more users.

According to various embodiments, the plurality of deformable walls 122 may be interconnected to form a repeating pattern. For example, the repeating pattern can include a grid such as a rectangular grid, square grid, triangular grid, pentagonal grid, hexagonal grid, etc. According to various embodiments, the repeating pattern may include a weave pattern, a patterned array of pillars of any shape, or various other repeating as well as random arrangements. The rectangular grid depicted in FIG. 2 is a non-limiting example, and any other pattern or deformable wall configuration is also contemplated herein.

According to various embodiments, the plurality of layers 110 may include one or more cover layers 114, where the one or more cover layers 114 form the resting surface 102 and/or the lower surface 106 of the mattress 100. The one or more cover layers 114 may include any suitable cloth which encompasses the comfort layer 112 and, according to various embodiments, one or more other layers of the plurality of layers 110. According to one embodiment, the one or more cover layers 114 may include a plurality of layers coupled together. The one or more cover layers 114 may include a fabric layer (e.g., a woven or non-woven fabric layer), pile-woven fabric, jacquard knitted fabric, double raschel fabric, quilting fabric made by weaving polyester yarns, nylon yarns, acrylic yarns, etc. a cotton fabric or cotton-blend fabric, and the like. According to one embodiment, the one or more cover layers 114 may include a moisture-proofing material (e.g., vinyl and/or polyurethane such as thermoplastic polyurethane) configured to prevent or inhibit liquid and/or moisture from passing through the one or more cover layers 114 in a depth direction D1.

According to various embodiments, the plurality of layers 110 include a fire resistant/repellant sock/cap layer (FR layer 116). According to various embodiments, the one or more cover layers 114 and the FR layer 116 may be contiguous consecutive layers, coupled together (e.g., sewn, glued, buttoned or otherwise affixed together), or loosely or freely arranged in an overlying/underlying arrangement. The FR layer 116 may be configured as a fireproof or fire-resistant layer that prevents, or at inhibits a fire from burning one or more of the plurality of layers covered by the FR layer 116. The FR layer may include any material(s) or configuration and may include a single layer or a plurality of layers (which may be coupled together). The FR layer may be treated (e.g., coated or impregnated) with fire proof or fire resistant material/chemical. The FR layer may include one or more sublayers of wool, glass fibers (e.g., fiberglass), ceramic (ceramic fibers), silica (silica fibers), Kevlar®, nylon, boric acid, antimony, chlorine, bromine, decabromodiphenyl oxide, and/or combinations thereof In some embodiments, the FR layer may be formed of a base material (e.g., cotton or a cotton blend) and the fireproof or fire-resistant material/chemical may be coupled to, coated, or otherwise integrated therewith.

The plurality of layers 110 may also include a base layer 118 forming a lower layer proximate the lower surface 106 of the mattress 100, according to various embodiments. The base layer 118 may include a layer of springs and/or resilient members, one or more layers of foam (e.g., viscoelastic foam, supportive foam, etc.), a structural framework (e.g. a wooden, metal, and/or plastic framework), an elastomeric polymer (e.g. latex), or other spacer material. The base layer 118 may include a height within a range of about 4 inches to about 8 inches, a range of about 5 inches to about 7 inches, or be about 6 inches.

According to various embodiments, the plurality of layers 110 may also include one or more middle layers positioned between the one or more comfort layers 114 and the base layer 118. The middle layer may include a height within a range of about 1 inch to about 6 inches, 2 inches to about 5 inches, 2.5 inches to about 4 inches, or about 3 inches.

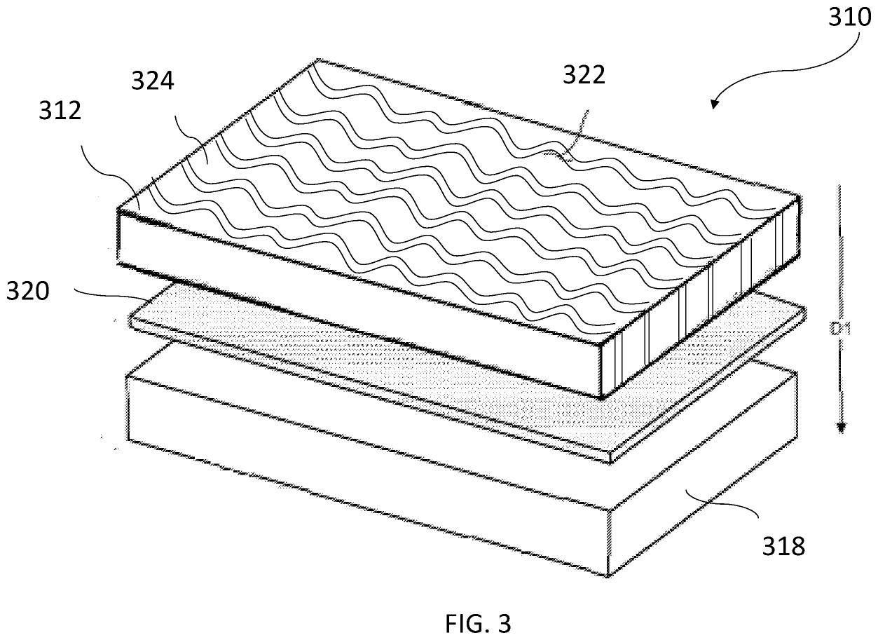

Referring now to FIG. 3, an elevational perspective view of a plurality of layers 310 used, for example, in a mattress, cushion, body-support pad or mat, are depicted. The plurality of layers 310 include a comfort layer 312 that includes a plurality of deformable walls 322 separated by voids 324, i.e., a recessed portion extending partly into the comfort layer 312. In one or more embodiments, the recessed portion can partly extend into both the top and bottom surface of the comfort layer. Additionally, a middle layer 320 and a base layer 318 or additional layers may be included. As depicted, the one or more of the deformable walls 322 may be irregularly shaped (e.g., without a pattern or alignment). In various other embodiments, the deformable walls 322 may be positioned in a columnar shape, may include or be configured as a plurality of individually supported spring-like structures positioned in array across the comfort layer 312, a grid-like array of pillars (e.g. columnar pillars, cross-shaped pillars, H-shaped pillars, T-shaped pillars, hexagonal-shaped pillars, etc.). According to various embodiments, the voids 324 may extend a depth of the comfort layer 312. According to various embodiments, the comfort layer 312 may include at least one edge-support surrounding at least a portion of the periphery of the comfort layer 312. For example, the at least one edge-support may include the deformable walls 322. The deformable walls 322 of the at least one edge-support may include the cushioning media and optionally the cushioning media may have a plurality of fiber strands embedded therein. According to various embodiments, the at least one edge-support may include a support structure having a higher rigidity than the deformable walls 322. According to one embodiment, the at least one edge-support may include a polymeric foam. According to one embodiment, the at least one edge-support may include a girdle to retain the shape and/or position of one or more of the deformable walls 322. Various embodiments may include at least one edge-support that is configured to provide structural support to one or more of the deformable walls. According to various embodiments, the edge-support may form a 0.25 inch to 4-inch perimeter of the comfort layer 312, and may include a higher resiliency material than the deformable walls 322. According to various embodiments, the edge-support may include a fiber mat/batting to facilitate airflow and provide higher resiliency. According to various embodiments, the edge-support may include Velcro® seams connecting the edge-support to the deformable walls 322.

According to various embodiments, the deformable walls 322 may include an additive material. The additive material may include a phase-change material, a metallic material, magnetizable material, etc. The additive material may be infused or microencapsulated within the deformable walls 322, or may be coated on a surface of the deformable walls. According to one embodiment, at least a portion of the additive material may be coextruded with one or more materials of the deformable walls.

According to various embodiments, the voids 324 that separate the deformable walls 322 may include one or more repeating shapes that extend in a depth direction. According to various embodiments, the voids may extend only a portion of the height of the deformable walls 322 or may extend the full height of the comfort layer 312. For instance, the repeating shapes may include a circular shape, triangular shape, square shape, rectangular shape, pentagonal shape, hexagonal shape, etc. According to one embodiment, a plurality of sidewalls of the deformable walls 322 define the one or more repeating shapes. As shown in FIG. 3, the voids 324 may extend a length of the comfort layer 312. In one or more embodiments, the one or more voids may extend a width of the mattress. In some embodiments, the voids may define one or more pillars that form the deformable walls 322. Various other void configurations or arrangements are also contemplated herein.

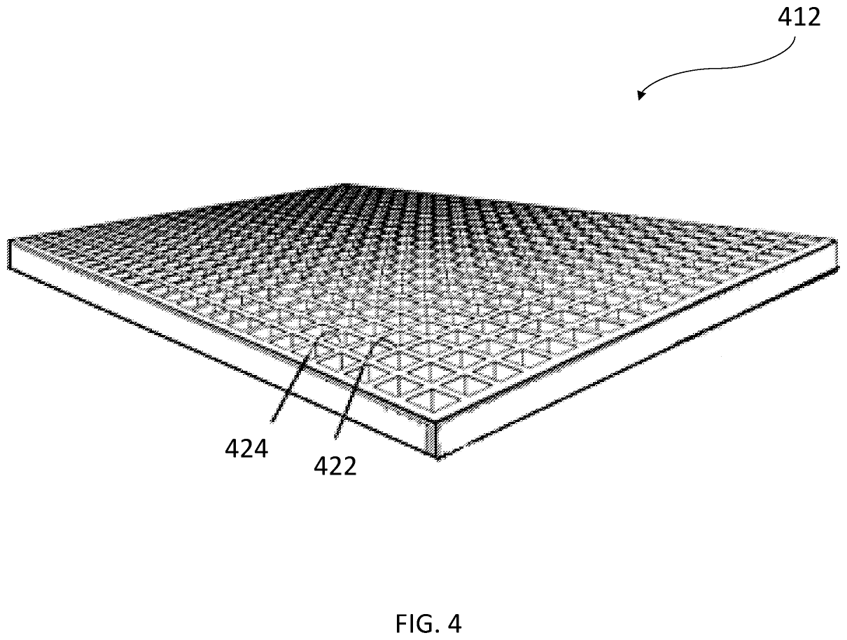

An example comfort layer 412 is depicted in FIG. 4, where the comfort layer 412 includes a plurality of deformable walls 422 arranged in a grid arrangement. The voids 424 are square-shaped and define the configuration of the deformable walls 422. The deformable walls 422 include a cushioning media, which may include an elastomeric polymer, an elastomeric gel, latex, polyurethane foam, and/or viscoelastic foam. According to one embodiment, the deformable walls may be thermoplastic and/or may include an elastomer extended by at least 20 parts of a plasticizer per 100 parts of the elastomer by weight. According to one embodiment, the cushioning media may include a triblock copolymer of approximately 16% polystyrene and approximately 67% poly(ethylene-butylene) and use mineral oil as a plasticizer. After processing, the polymer may orient into poly(ethylene-butylene) with polystyrene end caps, such that the structure of the cushioning media includes styrene ethylene butylene styrene (SEBS). According to various embodiments, the cushioning media may include styrene-ethylene-ethylene-propylene-styrene (SEEPS), styrene-ethylene-propylene-styrene (SEPS), or other elastomer. The cushioning media may include a gel rigidity from about a 20 gram to about a 700-gram bloom. The cushioning media may fuse to other surfaces (e.g. the plurality of fiber strands) at a temperature between 150° F. (65° C.) and 450° F. (232° C.), within a range between 200° F. (93.3° C.) and 400° F. (204.4° C.), between 200° F. (93.3° C.) and 350° F. (176.7° C.), or more particularly between 200° F. (93.3° C.) and 250° F. (121° C.). According to one embodiment, a sealant may be fused to the cushioning media at the aforementioned temperature range. The sealant may permeate through a portion of the cushioning media. The cushioning media may have a melting point at which the cushioning media may be infused within a range of about 150° F. (65° C.) and 450° F. 232° C.), within a range of about 200° F. (93.3° C.) and 400° F. (204.4° C.), or more particularly at approximately 350° F. (176.7° C.).

According to various embodiments, the cushioning media may include non-gel elastomers, high-durometer elastomers such as cross-linked latex rubber, cross-linked and non-cross-linked synthetic elastomers (e.g., SANTOPRENE® of any grade, KRATON® of any grade, SEPTON® of any grade, isoprene, butadiene, silicone rubber, thermoset or thermoplastic polyurethane, etc.), white food grade mineral oil (e.g., CARNATION® oil), polyurethane-based gels, silicone-based gels, polyvinylchloride-based (PVC-based) gels, acrylic-based gels, etc. In various embodiments the elastomer may be extended to at least 50:100 or by at least 100:100. Various acceptable elastomers are disclosed in U.S. Pat. Nos. 8,424,137; 7,060,213; 7,076,822; 6,908,622; 6,865,759; 6,797,765; 6,498,198; 6,413,458; 6,187,837; 6,026,527; 5,994,450, each of which is hereby incorporated by reference in its entirety.

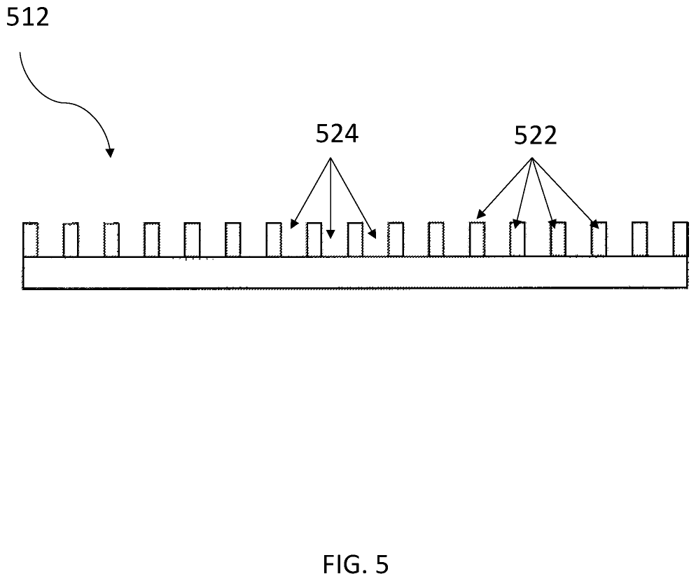

FIG. 5 depicts a side view of deformable walls 522 of an exemplary comfort layer 512 of a mattress, cushion, and/or body-support pad or mat. The deformable walls 522 are separated by voids 524 and, according to one embodiment, a plurality of the deformable walls 522 may at least partially attach to a first sheet of material that extends along the bottom of the comfort layer 512. The first sheet of material may include a same material as the deformable walls 522, or the first sheet of material may include a different material than the deformable walls 522. Although not shown in FIG. 5, a plurality of the deformable walls may be at least partially attached to a second sheet of material extending along a top layer of the comfort layer 512. According to various embodiments, the first sheet of material and the second sheet of material may include the same material compositions. According to other embodiments, the first sheet of material and the second sheet of material may include different material compositions. According to one embodiment, at least one of the first sheet of material and the second sheet of material may include a fiber mat/batting configured to facilitate airflow into the voids 524.

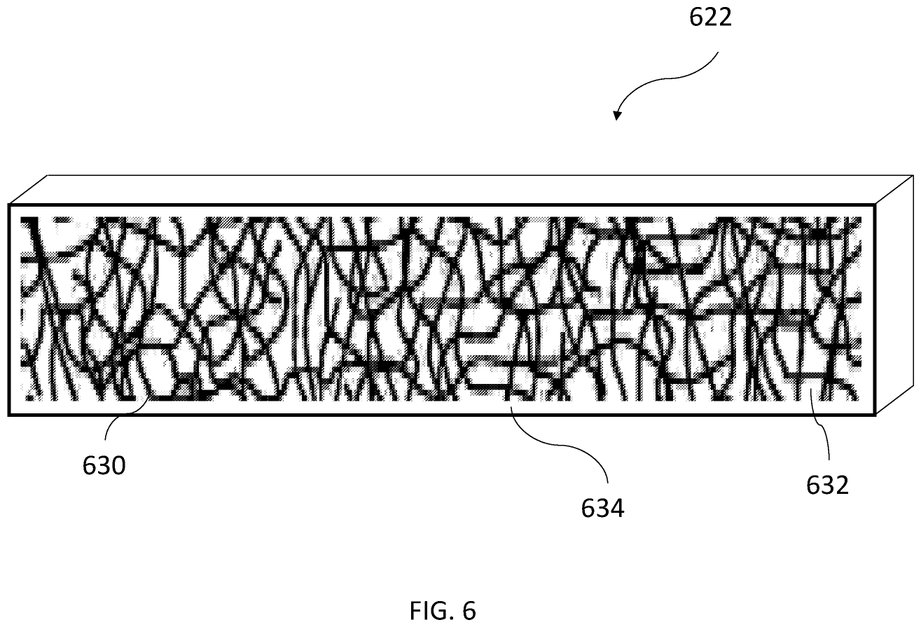

FIG. 6 depicts a transparent view of a portion of a deformable wall 622 that includes a plurality of fiber strands 630 embedded in a cushioning media 634, according to the present disclosure. According to one embodiment, the plurality of fiber strands may include a three-dimensional polymeric fiber matrix of strands with air pockets 632 formed between fiber strands 630. According to various embodiments, the plurality of fiber strands 630 includes randomly oriented polymeric fibers and/or a lattice of polymeric fibers oriented in a predefined arrangement. According to various embodiments, the fiber strands 630 can be solid or hollow and have cross-sections that are circular, triangular, or have other cross-sectional geometries (e.g. tri-lobular, channeled, and the like). Within the plurality of fiber strands 630 may be fiber strands of varying lengths that may or may not be interconnected. According to one embodiment, the fiber strands 630 may include a continuous filament extending a length of a deformable wall 622 of the deformable walls. According to one embodiment, the fiber strands 630 include polymeric fibers of varying thickness or having varying cross-sectional geometries. In one embodiment, a fiber of the fiber strands 630 may have an irregular cross-sectional area that varies across a length of the strand. In some embodiments, one fiber of the fiber strands 630 may have a smaller or larger cross-sectional area than another fiber of the fiber strands 630. According to one embodiment, the plurality of fiber strands 630 are distributed substantially uniformly within the cushioning media 634 and across a depth of the comfort layer. According to another embodiment, one portion of a deformable wall 622 may include a higher concentration of the fiber strands 630 than another portion of the deformable wall 622. For instance, one or more of the deformable walls 622 may include a gradient of the plurality of fiber strands distributed therein. According to one embodiment, a deformable wall 622 may include a higher percentage composition of the plurality of fiber strands 630 than another wall. According to one embodiment, the density of the plurality of fiber strands 630 may be within a range of about 20 kg/m³ to about 500 kg/m³. According to one embodiment, the free volume or air pockets 632 may range from about 40% to about 90% of the volume, 60% to about 80% of the volume, or about 70% of the volume when the fiber strands 630 are embedded in the cushioning media 634.

According to one embodiment, the plurality of fiber strands 630 may be coated with the cushioning media 634 or dipped in the cushioning media 634. In one embodiment, the fiber strands 630 may be pre-treated with acid, sand, air, or another abrasive technique may be used to roughen, scorch, or scratch the surface of the fiber strands 630 so that the cushioning media 634 may more readily adhere to the surface of the fiber strands 630. According to various embodiments, the plurality of fiber strands 630 may include thermoplastic resin fibers (e.g. polyethylene, polypropylene, polyester resin, polyamide resin, polyvinyl chloride resin, polystyrene resin, polylactic acid, or the like or combinations thereof), thermoplastic elastomers (e.g., polyethylene elastomers, polypropylene elastomers, polystyrene elastomers, vinyl chloride elastomers, olefin elastomers, urethane elastomers, polyester elastomers, nitrile elastomers, polyamide elastomers, fluorine elastomers, or the like or combinations thereof), nylon, copolymers and derivatives, monofilaments, bicomponent filaments, and/or one or more fibers having different melting points. According to one embodiment, the fiber strands 630 may be bound to a first sheet of material and/or a second sheet of material prior to the cushioning media 634 being applied such that the fiber strands 630 are embedded in the cushioning media 634. During formation, the fiber strands 630 may be arranged in a desired configuration or pattern such that when the cushioning media 634 solidifies around the fiber strands 630, the deformable walls 622 are formed in a desired configuration.

According to one embodiment, the plurality of fiber strands 630 may be co-extruded with the cushioning media 634 during formation. For example, the plurality of fiber strands 630 may include polyethylene (e.g., high-density polyethylene or low-density polyethylene) and/or polylactic acid. According to various embodiments, the melting point of the fiber strands 630 may be within a range of about 200° F. (913° C.) to about 550° F. (287.8° C.), in a range of about 350° F. (176.7° C.) and about 550° F. (287.8° C.), or more particularly at approximately 500° F. (260° C.). The co-extruded fiber strands 630 may provide a density of the extruded fiber strands 630 within the cushioning layer 634 of about 1.5 lb/ft³ to about 6 lb/ft³.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed compositions or methods.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

What is claimed is:

1. A mattress comprising:
a plurality of layers extending in a depth direction from a resting surface of the mattress, the resting surface being capable of supporting one or more users of the mattress, to a lower surface of the mattress, the lower surface being opposite the resting surface;
wherein the plurality of layers comprises at least one layer comprising deformable walls separated by voids, wherein the deformable walls comprise a plurality of fiber strands embedded in a cushioning media.

2. The mattress of claim 1, wherein the at least one layer comprises a height within a range of about 0.5 inches to about 4 inches.

3. The mattress of claim 1, wherein the voids comprise through holes extending from a top surface to a bottom surface of the at least one layer.

4. The mattress of claim 1, wherein the voids partly extend from a top surface to a bottom surface of the at least one layer.

5. The mattress of claim 1, wherein the deformable walls are configured as buckling walls capable of buckling due to pressure applied by an object.

6. The mattress of claim 1, wherein the deformable walls are interconnected to form a repeating pattern.

7. The mattress of claim 6, wherein the repeating pattern comprises a rectangular grid pattern, a weave pattern, a grid-like array of pillars or a triangular-shaped grid pattern.

8. The mattress of claim 1, wherein the deformable walls are positioned in a columnar shape.

9. The mattress of claim 1, wherein the deformable walls comprise a plurality of individually supported spring-like structures positioned in an array.

10. The mattress of claim 7, wherein the pillars comprise a columnar shape, a cross-shaped support pillar, an H-shaped support pillar, a T-shaped support pillar, a hexagonal shape or a combination comprising at least one of the foregoing.

11. The mattress of claim 1, wherein one or more of the deformable walls are irregularly shaped.

12. The mattress of claim 1, wherein the deformable walls are at least partially attached to a first sheet of material extending along the bottom of the comfort layer.

13. The mattress of claim 1, wherein the deformable walls are at least partially attached to a second sheet of material extending along a top layer of the comfort layer.

14. The mattress of claim 12, wherein the first sheet of material and the deformable walls comprise same material compositions.

15. The mattress of claim 12, wherein the first sheet of material and the deformable walls comprise different material compositions.

16. The mattress of claim 13, wherein the second sheet of material and the deformable walls comprise same material compositions.

17. The mattress of claim 13, wherein the second sheet of material as the deformable walls comprise different material compositions.

18. The mattress of claim 12, wherein the first sheet of material comprises a fiber mat or fiber batting configured to facilitate airflow into the voids.

19. The mattress of claim 13, wherein the second sheet of material comprises a fiber mat or fiber batting configured to facilitate airflow into the voids.

20. The mattress of claim 1 further comprising at least one edge-support surrounding at least a portion of the periphery of the at least one layer.

21. The mattress of claim 20, wherein the at least one edge-support comprises the deformable walls.

22. The mattress of claim 20, wherein the at least one edge-support comprises the cushioning media.

23. The mattress of claim 20, wherein the at least one edge support comprises the plurality of fiber strands embedded in the cushioning media.

24. The mattress of claim 20, wherein the at least one edge-support comprises a support structure having a higher rigidity than the deformable walls.

25. The mattress of claim 20, wherein the at least one edge-support comprises a polymeric foam.

26. The mattress of claim 20, wherein the at least one edge-support comprises a girdle to retain shape of one or more of the deformable walls.

27. The mattress of claim 20, wherein the at least one edge-support is configured to provide structural support to the deformable walls.

28. The mattress of claim 1, wherein the deformable walls further comprise an additive material.

29. The mattress of claim 28, wherein the additive material comprises a phase-change material, a metallic material, a magnetizable material or combinations comprising at least one of the foregoing additive materials.

30. The mattress of claim 28, wherein at least a portion of the additive material is microencapsulated within the deformable walls.

31. The mattress of claim 28, wherein at least a portion of the additive material is coated on the deformable walls.

32. The mattress of claim 28, wherein at least a portion of the additive material is coextruded with one or more materials of the deformable walls.

33. The mattress of claim 1, wherein the deformable walls comprise a composition of materials capable of providing a rebound force, due to compression from a planar load, within a range of about 100 kg/m² to about 400 kg/m2.

34. The mattress of claim 1, wherein the deformable walls are configured to distribute body weight of the one or more users while buckling/deforming to conform to body shape of the one or more users.

35. The mattress of claim 1, wherein the deformable walls buckle/deform within a range of about 5% deformity to about 85% deformity in response to a load from the one or more users.

36. The mattress of claim 1, wherein the voids comprise one or more repeating shapes.

37. The mattress of claim 36, wherein the one or more repeating shapes comprise at least one of a circular shape, a triangular shape, a square shape, a rectangular shape, a pentagonal shape, or a hexagonal shape.

38. The mattress of claim 1, wherein the deformable walls define the one or more repeating void shapes.

39. The mattress of claim 1, wherein one or more of the voids extend a length of the mattress.

40. The mattress according to claim 1, wherein one or more of the voids extend a width of the mattress.

41. The mattress according to claim 1, wherein the deformable walls comprise pillars.

42. The mattress of claim 1, wherein the plurality of fiber strands comprises a three-dimensional polymeric fiber matrix of strands.

43. The mattress of claim 1, wherein the plurality of fiber strands comprises randomly oriented polymeric fibers.

44. The mattress of claim 1, wherein the plurality of fiber strands comprises a lattice of polymeric fibers oriented in a predefined arrangement.

45. The mattress of claim 1, wherein the plurality of fiber strands comprise polymeric fibers of varying lengths.

46. The mattress of claim 1, wherein the plurality of fiber strands comprise polymeric fibers of varying thickness.

47. The mattress of claim 1, wherein the plurality of fiber strands comprises a continuous filament extending a length of a deformable wall of the deformable walls.

48. The mattress of claim 1, wherein the plurality of fiber strands are substantially uniformly distributed across a depth of the comfort layer.

49. The mattress of claim 1, wherein at least one wall of the deformable walls has a higher percentage composition of the plurality of fiber strands than at least one other wall of the deformable walls.

50. The mattress of claim 1, wherein one or more of the deformable walls comprise a gradient of the plurality of fiber strands distributed therein.

51. The mattress of claim 1, wherein the plurality of fiber strands embedded in the cushioning media have a density within a range of about 20 kg/m³ to about 500 kg/m³.

52. The mattress of claim 1, wherein the plurality of fiber strands comprises thermoplastic resin fibers.

53. The mattress of claim 52, wherein the thermoplastic resin fibers comprises one or more of polyethylene, polypropylene, polyester resin, polyamide resin, polyvinyl chloride resin, polystyrene resin, or combinations thereof

54. The mattress of claim 1, wherein the plurality of fiber strands comprises thermoplastic elastomers.

55. The mattress of claim 54, wherein the thermoplastic elastomers comprise polyethylene elastomers, polypropylene elastomers, polystyrene elastomers, vinyl chloride elastomers, olefin elastomers, urethane elastomers, polyester elastomers, nitrile elastomers, polyamide elastomers, fluorine elastomers, or combinations thereof.

56. The mattress of claim 1, wherein the cushioning media comprises an elastomeric polymer, an elastomeric gel, a latex foam, a polyurethane foam, or a viscoelastic foam.
